(19) United States
(12) Patent Application Publication
(10) Pub. No.: US 2006/0126464 A1
(43) Pub. Date: Jun. 15, 2006

(54) Information processing system, program, recording medium, and control method

(76) Inventors: Kosugi Tomoaki, Yokohama-shi (JP); Kazunobu Umeda, Machida City (JP); Noritoshi Yoshiyama, Yokohama-shi (JP)

Correspondence Address: DILLION & YUDELL, LLP, 8911 N CAPITAL OF TEXAS HWY, SUITE 2110, AUSTIN, TX, 78759, US

(21) Appl. No.: 11/198,590

(22) Filed: Aug. 5, 2005

(30) Foreign Application Priority Data
Aug. 5, 2004 (JP) 2004-228871

(51) Int. Cl. G11B 20/10

(52) U.S. Cl. 369/47.11

(57) ABSTRACT

An information processing system (IPS) including an external storage device having a drive control unit for performing reading/writing operations on a recording medium in response to a request from an operation system, in which the drive control unit transmits to the operation system a connection state response indicating that the external storage device is connected to the information processing system, when the drive control unit receives from the operation system a connection state request. The IPS includes: a power control unit for suspending a power supply to the drive control unit; a request substitutional receiving unit for receiving, in place of the drive control unit, the connection state request from the operation system when the power supply to the drive control unit is suspended; and a request substitutional replying unit for returning the connection state response indicating that the external storage device is connected to the information processing system.

### PRIORITY CLAIM

This application claims priority of Japanese Patent Application No. 2004-228871 filed on Aug. 5, 2004, and entitled, “Information Processing System, Program, Recording Medium, and Control Method.”

### BACKGROUND OF THE INVENTION

1. Technical Field

The present invention relates to an information processing system, a program, a recording medium, and a control method. More particularly, the present invention relates to an information processing system, a program, a recording medium, and a control method having a power saving function.

2. Description of Related Art

Recently, people often carry around information processing systems such as personal computers, and use them at places where they have gone. As a problem to enhance the convenience when the information processing systems are taken along with the people, lengthening an operable time by a battery will be cited. In contrast to this, research has been, heretofore, conducted on the technologies which can reduce the power consumption of an information processing system. For example, there have been proposed the technologies which can reduce the power consumption of an optical drive that is not so frequently used (Refer to Japanese Patent Application Laid-open No. 2003-272277 (Patent Literature 1) and Japanese Patent Application Laid-open No. 2003-77211 (Patent Literature 2)). According to Patent Literature 1, when an optical drive is not operated for a predetermined period of time, a control chip for controlling the optical drive is set to an operation mode where an operation is performed with lower power consumption. Meanwhile, according to Patent Literature 2, for an optical drive which can perform reading/writing operations on a plurality of kinds of optical media, there has been proposed a technology where electrical power is supplied only to a circuit with which reading/writing operations are performed on an optical medium currently loaded, while electrical power is suspended to a circuit with which reading/writing operations are performed on other kinds of optical media. According to these technologies, it is possible to reduce the power consumption and the wear of an optical drive.

However, even if any of the above-described technologies is applied, it is not possible to suspend the power supply to at least a part of a chip for control included in an optical drive. This is because, when regularly receiving an inquiry about the state of an optical drive from an operating system (hereinafter referred to as an OS), it is necessary to perform a process for properly replying to the inquiry.

Incidentally, instead of the above-described technologies, a method is conceived, in which an optical drive is previously provided onto an information processing system detachably and the optical drive is detached from the information unit when the optical drive is not used. According to this method, since the electrical power is not supplied to the optical drive, it is possible to reduce the power consumption. However, this method requires a user to mount the optical drive on the information processing system whenever using the optical drive, hence making operations cumbersome.

Furthermore, when the optical drive is once demounted from and then remounted on the information processing system, it becomes necessary to initialize to cause the OS to start controlling the optical drive. For example, the OS needs to perform the processes such as determining of the data transfer mode between the optical drive and the information processing system, acquiring and displaying of a volume name of the optical media, and mounting the content of the optical media as a part of a file system. As a result of this, in some cases, it takes a long time until the optical drive is ready to be used after it is mounted.

### SUMMARY OF THE INVENTION

Therefore, an objective of the present invention is to provide an information processing system, a program, a recording medium, and a control method, which can solve the above-described problems. This objective is achieved by combining the aspects described in the independent claims of the appended claims. Moreover, the dependent claims thereof define further advantageous embodiments.

In order to solve the above-described problems, as a first aspect of the present invention, there are provided an information processing system, a control method employing the information processing system, a program controlling the information processing system, and a recording medium with programs recorded thereon, the information processing system including a central processing unit for executing an operating system (hereinafter referred to as an OS), and an external storage device having a drive control unit for performing reading/writing operations on a recording medium in response to a request from the OS, in which the drive control unit transmits to the OS a connection state response indicating that the external storage device is connected to the information processing system in an accessible state where the external storage device can read/write, when the drive control unit receives from the OS a connection state request inquiring about whether or not the external storage device is connected to the information processing system in the accessible state, the information processing system comprising: a power control unit for suspending a power supply to the drive control unit; a request substitutional receiving unit for receiving the connection state request from the OS to the drive control unit in place of the drive control unit, when the power supply to the drive control unit is suspended; and a request substitutional replying unit for returning the connection state response indicating that the external storage device is connected to the information processing system in the accessible state, when the request substitutional receiving unit receives the connection state request.

The summary of the above-described invention does not enumerate all of the necessary aspects in the present invention, and a sub-combination of the group of these aspects also derives an invention.

### BRIEF DESCRIPTION OF THE DRAWINGS

For a more complete understanding of the present invention and the advantages thereof, reference is now made to the following description taken in conjunction with the accompanying drawings.

FIG. 1 is a configuration of an information processing system 10.

FIG. 2 is a schematic view showing an optical drive 1060.

FIG. 3 is a schematic view showing a communication interface 1030.

FIG. 4 is a functional block diagram for a central processing unit 1000.

FIG. 5 is a flowchart showing a process for suspending a power supply to an optical drive.

FIG. 6 is a flowchart showing a process where the optical drive 1060 receives a request from an operation system.

FIG. 7 is a flowchart showing a process of starting a power supply to the optical drive 1060.

### DETAILED DESCRIPTION OF THE PREFERRED EMBODIMENT

The present invention will be described below using an embodiment. However, the following embodiment does not limit the inventions according to the scope of claims, and further all of the combinations of features described in the embodiment are not necessarily essential for the solving means of the invention.

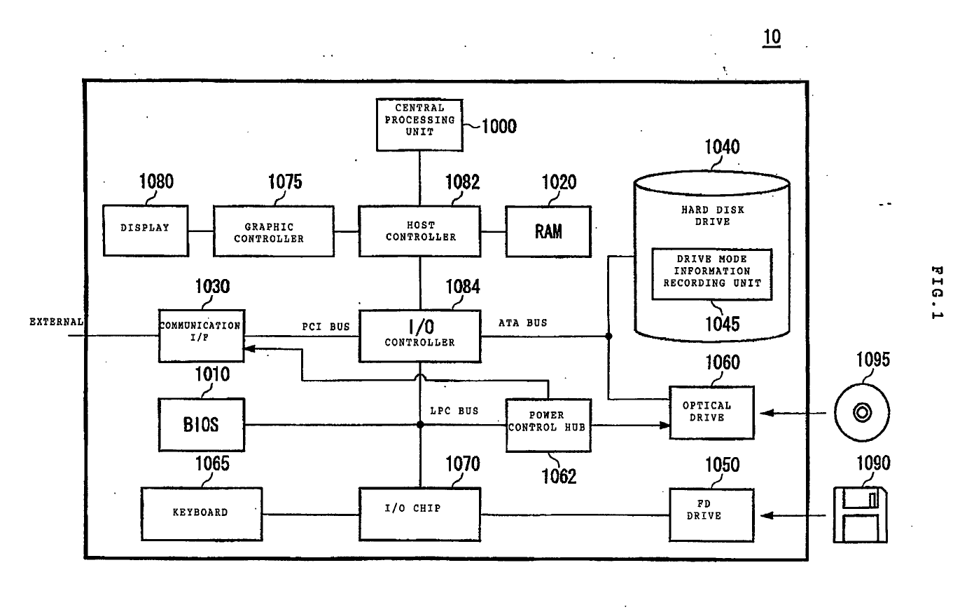

FIG. 1 is a diagram showing a configuration of an information processing system 10. The information processing system 10 includes a CPU periphery unit which has a CPU 1000, a RAM 1020, and a graphic controller 1075 that are connected to one another through a host controller 1082; an input/output unit which has a communication interface 1030, a hard disk drive 1040, and an optical drive 1060 which are connected to the host controller 1082 through an I/O controller 1084; and a legacy input/output unit which has a BIOS 1010, a flexible disk drive 1050, a power control hub 1062, and an input/output chip 1070 that are connected to the I/O controller 1084.

The host controller 1082 connects the RAM 1020 with the graphic controller 1075 and the CPU 1000 which access the RAM 1020 at a high transfer rate. The CPU 1000 operates based on the programs stored in the BIOS 1010 and the RAM 1020, and controls each part. The graphic controller 1075 acquires image data which are generated on a frame buffer provided in the RAM 1020, by the CPU 1000 and the like, so as to be displayed on a display 1080. Alternatively, the graphic controller 1075 may include therein a frame buffer storing image data to be generated by the CPU 1000 and the like.

The I/O controller 1084 connects the host controller 1082 with the optical drive 1060, the hard disk drive 1040, and the communication interface 1030, which are input/output units with a relatively high transfer rate. The communication interface 1030 is connected to the I/O controller 1084 through a PCI bus and the like, and is communicated with external devices through networks. For example, the communication interface 1030 has a port for Ethernet™, and communicates with another information processing system externally provided through the Ethernet™.

The optical drive 1060 reads a program or data from an optical recording medium 1095, and provides the program or the data to the central processing unit 1000 or the like through the RAM 1020. Here, the optical drive 1060 is an example of an external storage device according to the present invention. For example, the optical drive 1060 is a device which reads data from a recording medium of an optical recording system such as a CD-ROM drive or a DVD-ROM drive.

In addition to this, the optical drive 1060 may have a function of writing data on a recording medium of an optical recording system. For example, the optical drive 1060 may be a CD-R/RW, or a recording device which is compliant with various kinds of the DVD writing standards. Alternatively, the external storage device may be a storage device which is different from a main memory, such as a hard disk drive, a tape drive, or a nonvolatile memory.

The hard disk drive 1040 stores programs and data to be used by the information processing system 10. For example, the hard disk drive 1040 records drive mode information, which determines a data transfer mode and the like of the optical drive 1060, that is set to a drive control unit 220. Here, the data transfer mode is a mode of data transfer where data transfer is effected through a connection interface between the optical drive 1060 and the I/O controller 1084.

Incidentally, the BIOS 1010, the power control hub 1062, and an input/output unit with a relatively low transfer rate such as the input/output chip 1070 are connected to the I/O controller 1084. The BIOS 1010 stores a boot program, which is executed by the CPU 1000 at the time of starting the information processing system 10, a program which depends on the hardware of the information processing system 10, and the like. The flexible disk drive 1050 reads a program or data from a flexible disk 1090, and provides the program or the data to the central processing unit 1000 through the RAM 1020.

The power control hub 1062 controls the power supply to the optical drive 1060, the communication interface 1030, or the like in response to an instruction by a program and the like to be executed by the central processing unit 1000. The input/output chip 1070 connects to the flexible disk drive 1050, a keyboard 1065, and the various kinds of input/output units to one another, through parallel ports, serial ports, mouse ports and the like, for example.

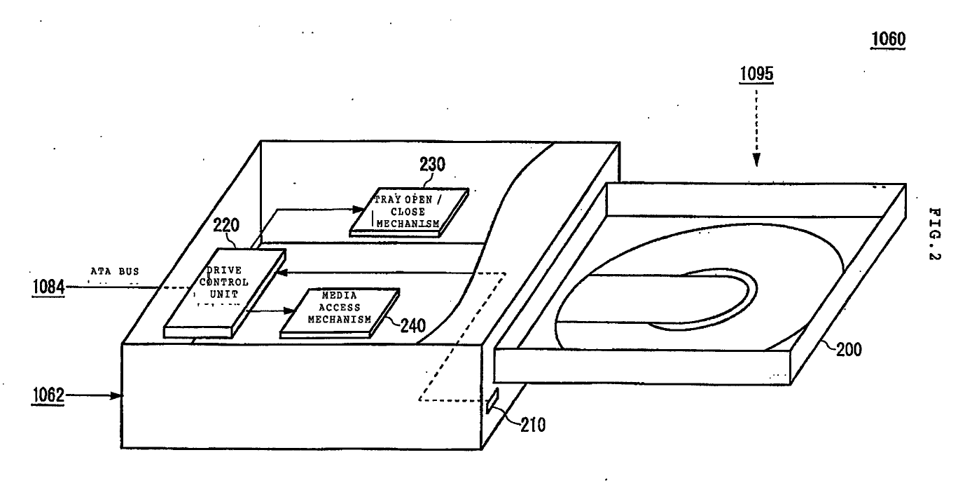

A program to be provided to the information processing system 10 has been recorded in a recording medium such as the flexible disk 1090, the optical recording medium 1095, or an IC card, and is provided by a user. The program is read from the recording medium through the input/output chip 1070 and/or the I/O controller 1084, and is installed on and executed by the information processing system 10. The operations, which are performed by the information processing system 10 or the like, after a program that is executed by the information processing system 10 works on the information processing system 10 and the like are same as those by the information processing system 10 to be described in FIGS. 2 to 7, hence omitting the explanation.

The program described above may be stored in an external storage medium. As the storage medium, it is possible to employ an optical recording medium such as a DVD and a PD, a magnetic optical recording medium such as an MD, a tape medium, a semiconductor memory such as an IC card, and the like, besides the flexible disk 1090 and the optical recording medium 1095. It is allowed to use, as a recording medium, a storage device such as a RAM, a hard disk, or the like provided in a server system which is connected to a private communication network and the Internet, and to provide a program to the information processing system 10 through a network.

FIG. 2 is a schematic view showing the optical drive 1060. The optical drive 1060 is controlled by the power control hub 1062, and comes to an operable state when the optical drive 1060 is supplied with electrical power. Further, the optical drive 1060 is configured with a housing that includes a drive body unit that is a mechanism on which a recording medium is mounted and which performs reading/writing operations, and a drive control unit 220 for controlling the drive body unit. To be more specific, the optical drive 1060 includes, as an example of the drive body unit, a media tray 200, a tray switch 210, a tray open/close mechanism 230, and a media access mechanism 240. The media tray 200 is provided in a manner that it is made possible to open and close, and has the optical recoding medium 1095 to be mounted thereon. The tray switch 210 instructs the drive control unit 220 so as to open/close the media tray 200, when the tray switch 210 is operated by a user.

The drive control unit 220 instructs the tray open/close mechanism 230 so as to open/close the media tray 200, in response to the instruction by the tray switch 210. Meanwhile, the drive control unit 220 receives various kinds of requests from the OS through a data transmission path between the optical drive 1060 and the central processing unit 1000, and responds to the requests. To be more specific, the data transmission path includes, as its part, an ATA bus that is a connection interface between the optical drive 1060 and the I/O controller 1084. Furthermore, as an example of a process, the drive control unit 220 may instruct the media access mechanism 240 in response to a request from an OS, and perform reading/writing operations on the optical recording medium 1095.

Incidentally, when the drive control unit 220 receives from the OS a connection state request inquiring about whether or not the optical drive 1060 is connected to the information processing system 10 in a state where the optical drive 1060 can read and write, the drive control unit 220 transmits to the OS a connection state response indicating that the optical drive 1060 is connected to the information processing system 10 in a state where the optical drive 1060 can read and write. In addition to this, the drive control unit 220 transmits drive mode information as a connection state response to the OS, the drive mode information indicating at least one of the followings: a data transfer mode between the optical drive 1060 and the I/O controller 1084 set to the drive control unit 220, whether or not a recording medium is mounted on the optical drive 1060, and information discriminating the recording medium mounted on the optical drive 1060.

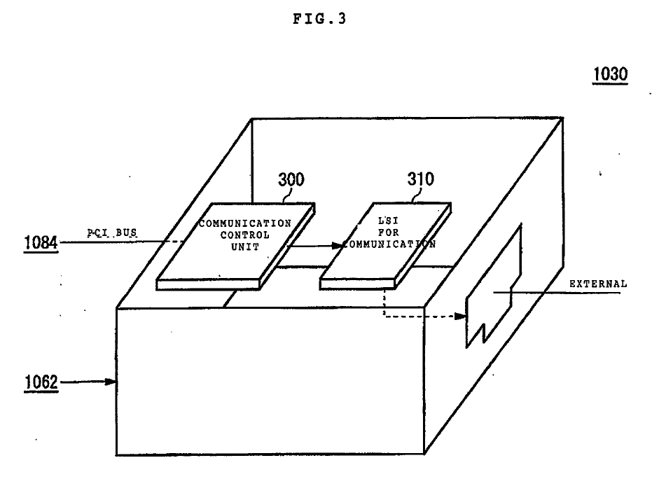

FIG. 3 is a schematic view showing the communication interface 1030. The communication interface 1030 is controlled by the power control hub 1062, and comes to an operable state when the power is supplied to the communication interface 1030. Further, the communication interface 1030 includes an LSI 310 for communication, which is an example of a communication unit communicating with external devices, and a communication control unit 300 which controls the LSI 310 for communication in response to a request from the OS. The LSI 310 for communication communicates with an external device through a port for communication such as Ethernet (Trademark), for example.

The communication control unit 300 receives various kinds of requests from the OS through a PCI bus that is a connection interface between the communication interface 1030 and the I/O controller 1084, and responds to the requests. For example, when the communication control unit 300 receives from the OS a connection state request inquiring about whether or not the communication interface 1030 is connected to the information processing system 10 in a state where the communication interface 1030 is capable of communicating with the information processing system, the communication control unit 300 transmits to the OS a connection state response indicating that the communication interface 1030 is connected to the information processing system 10 in a state where the communication interface 1030 is capable of communicating with the information processing system.

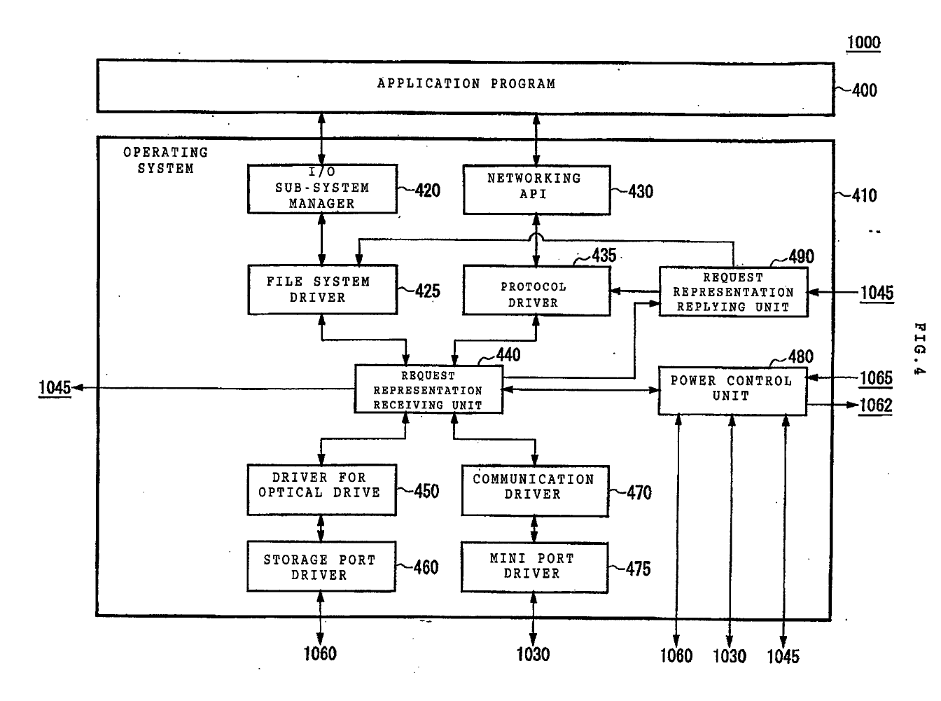

FIG. 4 is a functional block diagram for the central processing unit 1000. A program installed on the information processing system 10 causes the central processing unit 1000 to function as an application program 400 and an operating system 410. The application program 400 operates in response to an instruction by a user or autonomously, and instructs the operating system 410 reading/writing by the optical drive 1060 or communication by the communication interface 1030. The operating system 410 controls the optical drive 1060 or the communication interface 1030 in response to an instruction by the application program 400, a timer interrupt, or the like.

The operating system 410 includes an I/O subsystem manager 420, a file system driver 425, a networking API 430, a protocol driver 435, a request substitutional receiving unit 440, a driver for optical drive 450, a storage port driver 460, a communication driver 470, a mini port driver 475, a power control unit 480, and a request substitutional replying unit 490.

When receiving a request of an access to an input/output device from the application program 400, the I/O subsystem manager 420 requests the file system driver 425 an access to a file system. Meanwhile, the I/O subsystem manager 420 may transmit, for example, regularly to the file system driver 425 a connection state request inquiring about whether or not the optical driver 1060 is connected to the information processing system 10 in a state where the optical drive 1060 can read and write. The file system driver 425 transmits a request of an access to an input/output device to the request substitutional receiving unit 440 based on a request received from the I/O subsystem manager 420.

When receiving a request to the optical driver 1060 from the file system driver 425, the request substitutional receiving unit 440 determines whether or not the power supply to the driver control unit 220 is at a halt. In the case where the power supply to the driver control unit 220 is at a halt, when a received request is a connection state request, the request substitutional receiving unit 440 transmits the connection state request to the request substitutional replying unit 490. On the other hand, when a received request is a reading/writing request, the request substitutional receiving unit 440 transmits the reading/writing request to the driver for optical drive 450.

Meanwhile, when the power is supplied to the drive control unit 220, the request substitutional receiving unit 440 transmits a received request to the driver for optical drive 450. After receiving this request, the driver for optical drive 450 controls the optical drive 1060 along with the storage port driver 460. For example, the driver for optical drive 450 may read data from a recording medium in the optical drive 1060 along with the storage port driver 460, and may provide the data to the application program 400.

When receiving a request for communication using the communication interface 1030 from the application program 400, the networking API 430 requests the protocol driver 435 a control on the communication interface 1030. Further, the networking API 430 transmits, for example, regularly to the protocol driver 435 a connection state request inquiring about whether or not the communication interface 1030 is connected to the information processing system 10 in a state where the communication interface 1030 is capable of communicating with the information processing system. The protocol driver 435 performs a process such as a protocol control in response to the received request, and transmits the received request to the request substitutional receiving unit 440.

When receiving a request to the communication interface 1030 from the protocol driver 435, the request substitutional receiving unit 440 determines whether or not the power supply to the communication control unit 300 is at a halt. In the case where the power supply to the communication control unit 300 is at a halt, when a received request is a connection state request, the request substitutional receiving unit 440 transmits the connection state request to the request substitutional replying unit 490. On the other hand, when the received request is a request for communication, the request substitutional unit 440 transmits the request for communication to the communication driver 470.

Meanwhile, when the power is supplied to the communication control unit 330, the request substitutional receiving unit 440 transmits the received request to the communication driver 470. After receiving this request, the communication driver 470 controls communication by the communication interface 1030, along with the mini port driver 475.

The power control unit 480 instructs the power control hub 1062 the power supply to the communication interface 1030 and the optical driver 1060, and controls the supply thereof. For example, when the optical driver 1060 is not used for a predetermined period of time, the power control unit 480 stops the power supply to the drive control unit 220 of the optical drive 1060. Furthermore, when the request substitutional receiving unit 440 receives a request for the optical drive 1060 to read/write data from the operating system 410, the power control unit 480 instructs the power control hub 1062 to start the power supply to the drive control unit 220 and the communication control unit 300. Meanwhile, the power control unit 480 may start supplying power in response to a key input to the keyboard 1065.

Incidentally, it is preferred that, when the power supply to the communication interface 1030 or the optical drive 1060 is suspended, the power control unit 480 reads various kinds of information set in the communication interface 1030 or the optical drive 1060 at the time of suspending the power supply, and retreats the various kinds of information into a drive mode information recording unit 1045. Further, when the power supply to the communication interface 1030 or the optical drive 1060 is resumed, the power control unit 480 reads, from the drive mode information recording unit 1045, the information that has been retreated therein at the time of suspending the power supply, and sets the information into the communication interface 1030 or the optical drive 1060.

When the request substitutional receiving unit 440 receives a connection state request from the file system driver 425, the request substitutional replying unit 490 returns to the file system driver 425 a connection state response indicating that the optical drive 1060 is connected to the information processing system 10 in a state where the optical drive 1060 can read and write. Further, when the request substitutional receiving unit 440 receives a connection state request from the protocol driver 435, the request substitutional replying unit 490 returns to the protocol driver 435 a connection state response indicating that the communication interface 1030 is connected to the information processing system 10 in a state where the communication interface 1030 is capable of communicating with the information processing system.

As described in FIG. 4, as to a connection state request to be transmitted to the optical drive 1060 or the communication interface 1030 through an ATA bus, a PCI bus or the like from the operating system 410, the request substitutional receiving unit 440 receives the connection state request in place of the drive control unit 220 or the communication control unit 300, without through these connection interfaces. In that case, the request substitutional replying unit 490 returns, in place of the drive control unit 220 or the communication control unit 300, a connection state response indicating that the optical drive 1060 is connected to the information processing system 10 in a state where the optical drive 1060 can read and write, or that the communication interface 1030 is connected to the information processing system 10 in a state where the communication interface 1030 is capable of communicating with the information processing system. In this manner, even when the power supply to the entire optical drive 1060 is suspended, it is possible to cause the operating system 410 to recognize that the optical drive 1060 is connected to the information processing system 10.

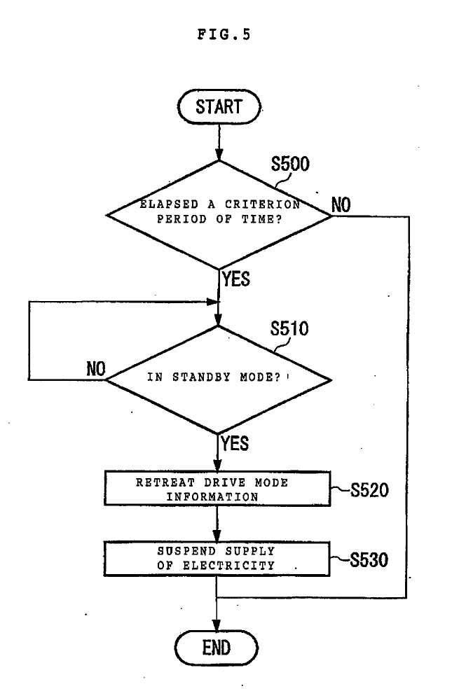

FIG. 5 is a flowchart showing a process for suspending a power supply to the optical drive 1060. While the information processing system 10 controls the power supply to the communication interface 1030 and the optical drive 1060, controlling of the power supply to the optical drive 1060 will be described below as an example.

The information processing system 10 performs the following processes regularly, for example. The power control unit 480 determines whether or not a predetermined period of time elapses after the optical drive 1060 was previously used (S500). When a criterion period of time has elapsed (S500: YES), the power control unit 480 waits until the optical drive 1060 comes to a standby mode where it is possible to process a next request while the optical drive 1060 is not in the state of processing a request received from the operating system 410 (S510).

When the optical drive 1060 comes to a standby mode (S510: YES), the power control unit 480 retreats drive mode information into the drive mode information recording unit 1045, where the drive mode information is various kinds of setting information set to the drive control unit 220 (S520). Here, the drive mode information is information indicating at least one of the following: for example, a data transfer mode between the optical drive 1060 and the I/O controller 1084, whether or not the optical recording medium 1095 is mounted on the optical drive 1060, and information discriminating the optical recording medium 1095 mounted on the optical drive 1060. Next, the power control unit 480 suspends the power supply to the optical drive 1060.

In this manner, the power control unit 480 is capable of suspending the power supply not only to a part of the optical drive 1060, but also to the whole including the drive control unit 220. Furthermore, when the power control unit 480 suspends the power supply to the drive control unit 220, the drive mode information recording unit 1045 stores drive mode information and the like, each one being information at the time of suspending the power supply to the drive control unit 220. As a result of this, even when the power supply to the optical drive 1060 is suspended, drive mode information and the like can be returned to the OS properly.

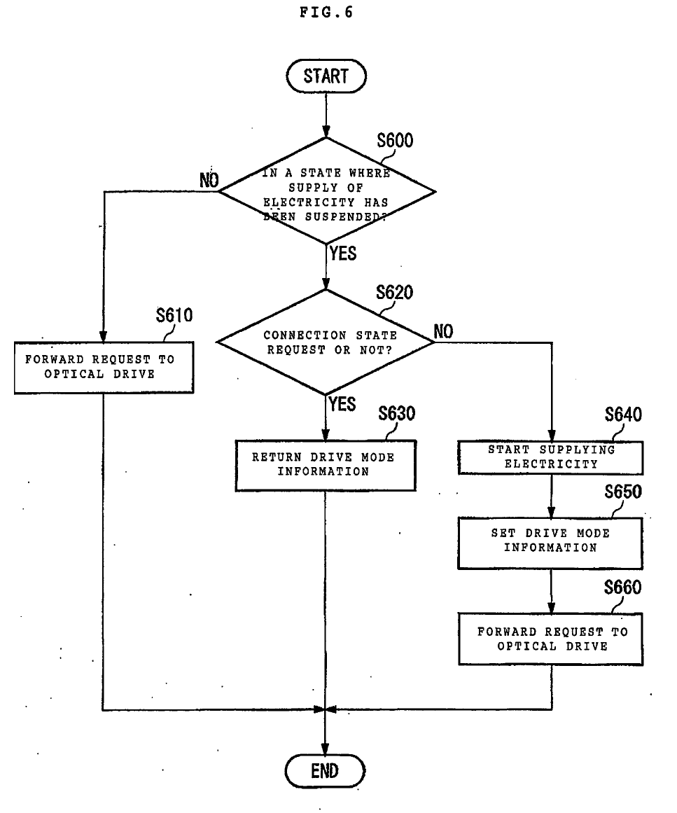

FIG. 6 is a flowchart showing a process where the optical drive 1060 receives a request from the OS. The request substitutional receiving unit 440 performs the following processes for every time the request substitutional receiving unit 440 receives a request to the optical drive 1060, for example. When the power is supplied to the optical drive 1060 (S600: NO), the request substitutional receiving unit 440 forwards the received request to the optical drive 1060 (S610).

Meanwhile, when the power supply to the optical drive 1060 is suspended (S600: YES), the request substitutional receiving unit 440 determines whether or not the received request is a connection state request (S620). When the received request is a connection state request (S620: YES), the request substitutional replying unit 490 returns a connection state response having included drive mode information and the like (S630). For example, when a received request is a connection state request inquiring about whether or not the drive mode information of the optical drive 1060 has changed, the request substitutional replying unit 490 returns a connection state response indicating that the drive mode information has not changed.

On the other hand, in the case where the received request is not a connection state request, for example in the case where the received request is a request of reading/writing data (S620: NO), the power control unit 480 instructs the power control hub 1062, and starts supplying power to the optical drive 1060 (S640). Then, the power control unit 480 acquires drive mode information having been retreated in S520 from the drive mode information recording unit 1045, and sets the drive mode information to the optical drive 1060 (S650). Subsequently, the request substitutional receiving unit 440 forwards the request of reading/writing data to the optical drive 1060 (S660).

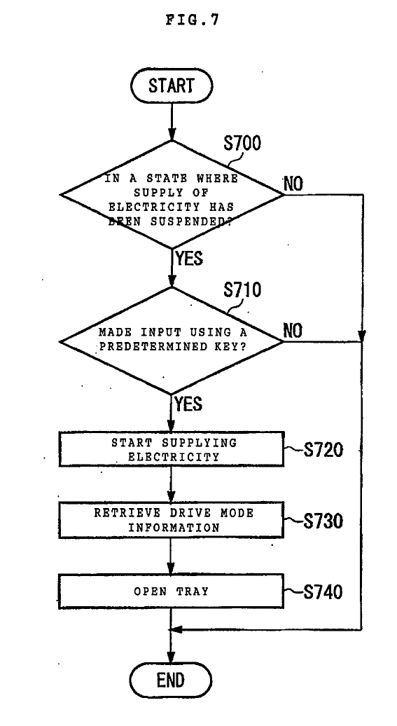

FIG. 7 is a flowchart showing a process of starting a power supply to the optical drive 1060. The power control unit 480 performs the following processes for every time the keyboard 1065 receives a key input, for example. Firstly, when suspending the power supply to the optical drive 1060 (S700: YES), the power control unit 480 determines whether or not an input is made using at least one key determined beforehand in the keyboard 1065 (S710).

Then, when the input is made using the key (S710: YES), the power control unit 480 starts supplying power to the drive control unit 220 of the optical drive 1060 (S720). Next, the power control unit 480 acquires drive mode information from the drive mode information recording unit 1045, and sets the drive mode information to the drive control unit 220 (S730). Further, the power control unit 480 instructs the drive control unit 220 to open/close the media tray 200 (S740).

In this way, according to the process in FIG. 7, even when the power supply to the drive control unit 220 is suspended, and the media tray 200 is not caused to open/close when the tray switch 210 is operated, it is possible to open/close the media tray 200 through inputting to the keyboard 1065.

As described above, according to the information processing system 10 in the present embodiment, as to input/output devices such as an optical drive, it is possible to suspend supplying power not only to a part such as a motor drive unit, but also to the whole. Moreover, even when suspending the power supply, it is still possible to reply properly the state of the optical drive for a request from the operating system. As a result of this, since a procedure of initialization or the like is no longer necessary at the time of resuming the power supply, it is possible to reduce the power consumption without losing users' convenience.

As in the above-described, while the present invention has been described by making use of the embodiment, the scope of technology according to the present invention is not restrictive to the scope of the foregoing description for the embodiment. It is obvious for one skilled in the art that various changes or modifications can be made in the above-described embodiment. It is clear from the appended claims that an embodiment where such changes or modifications are added is also embraced within the scope of technology according to the present invention.

What is claimed is:

1. An information processing system comprising:
a central processing unit for executing an operating system;
an external storage device having a drive control unit for performing reading/writing operations on a recording medium in response to a request from the operating system;
wherein the drive control unit transmits to the operating system a connection state response indicating that the external storage device is connected to the information processing system in an accessible state for reading/writing operations on the external storage device when the drive control unit receives from the operating system a connection state request inquiring about whether or not the external storage device is connected to the information processing system in the accessible state;
a power control unit for suspending a power supply to the drive control unit;
a request substitutional receiving unit for receiving the connection state request from the operating system to the drive control unit in place of the drive control unit, when the power supply to the drive control unit is suspended; and
a request substitutional replying unit for returning the connection state response indicating that the external storage device is connected to the information processing system in the accessible state, when the request substitutional receiving unit receives the connection state request.

2. The information processing system according to claim 1, wherein:
the external storage device includes a drive body unit mounting a recording media and the drive control unit on the same housing;
the drive control unit receives from the operation system the connection state request through a data transmission path between the external storage device and the central processing unit; and
the request substitutional receiving unit receives the connection state request without using the data transmission path.

3. The information processing system according to claim 1, wherein, when the external storage unit is not used for a predetermined period of time, the power control unit suspends supplying electricity to the drive control unit under conditions where the external storage unit is not in a state of processing a request received from the operation system, and is in a standby mode in which it is available to process a next request.

4. The information processing system according to claim 1, wherein the power control unit starts supplying power to the drive control unit, when the power control unit receives from the operation system a request for reading/writing data from/on the external storage device.

5. The information processing system according to claim 1, wherein the external storage device further comprises:
a media tray on which the recording medium is mounted, and which is provided in a state where it is possible to open/close the media tray; and
a tray switch for instructing the drive control unit, and opening/closing the media tray, when the tray switch is operated by a user, and
wherein, in a case where a power supply to the drive control unit is suspended, the power control unit starts supplying power to the drive control unit and instructs the drive control unit to open/close the media tray, if an input is made using at least one key predetermined in a keyboard for inputting information into the information processing system.

6. The information processing system according to claim 1, wherein:
when the drive control unit receives the connection state request, the drive control unit transmits drive mode information to the operation system as the connection state response, the drive mode information indicating at least one of the following: a data transfer mode for the external storage device set to the drive control unit, whether or not a recording medium is mounted on the external storage device, and information discriminating the recording medium mounted on the external storage device;
the information processing system further comprises a drive mode information recording unit for recording the drive mode information which is information at the time of suspending a power supply to the drive control unit, when the power control unit suspends supplying power to the drive control unit; and
when the request substitutional receiving unit receives the connection state request, the request substitutional replying unit reads the drive mode information from the drive mode information recording unit, and further returning the drive mode information as the connection state response.

7. The information processing system according to claim 6, wherein, when the request substitutional receiving unit receives a connection state request inquiring about whether or not the drive mode information of the external storage device has changed, the request substitutional replying unit returns as the connection state response a content indicating that the drive mode information of the external storage device has not changed.

8. The information processing system according to claim 6, wherein, when a power supply to the drive control unit is resumed, the power control unit acquires the drive mode information from the drive mode information recording unit, and sets the drive mode information to the drive control unit.

9. An information processing system comprising:
a central processing unit for executing an operating system;
a communication device having a communication control unit for controlling a communication unit communicating with an external device in response to a request from the operation system;
wherein, when the communication control unit receives from the operation system a connection state request inquiring about whether or not the communication device is connected to the information processing system in an available state where the communication device is available to communicate with the information processing system, the communication control unit transmits to the operation system a connection state response indicating that the communication device is connected to the information processing system in the available state;
a power control unit for suspending a power supply to the communication control unit;
a request substitutional receiving unit for receiving the connection state request to the communication control unit from the operation system in place of the communication control unit, when the power supply to the communication control unit is suspended; and
a request substitutional replying unit for returning the connection state response indicating that the communication device is connected to the information processing system in the available state, when the request substitutional receiving unit receives the connection state request.

10. The information processing system according to claim 9, wherein:
the external storage device includes a drive body unit mounting a recording media and the communication control unit on the same housing;
the communication control unit receives from the operation system the connection state request through a data transmission path between the external storage device and the central processing unit; and
the request substitutional receiving unit receives the connection state request without using the data transmission path.

11. The information processing system according to claim 9, wherein, when the external storage unit is not used for a predetermined period of time, the power control unit suspends supplying electricity to the communication control unit under conditions where the external storage unit is not in a state of processing a request received from the operation system, and is in a standby mode in which it is available to process a next request.

12. The information processing system according to claim 9, wherein the power control unit starts supplying power to the communication control unit, when the power control unit receives from the operation system a request for reading/writing data from/on the external storage device.

13. The information processing system according to claim 9, wherein the external storage device further comprises:
a media tray on which the recording medium is mounted, and which is provided in a state where it is possible to open/close the media tray; and
a tray switch for instructing a drive control unit, and opening/closing the media tray, when the tray switch is operated by a user, and
wherein, in a case where a power supply to the drive control unit is suspended, the power control unit starts supplying power to the drive control unit and instructs the drive control unit to open/close the media tray, if an input is made using at least one key predetermined in a keyboard for inputting information into the information processing system.

14. The information processing system according to claim 9, wherein:
when the communication control unit receives the connection state request, the drive control unit transmits drive mode information to the operation system as the connection state response, the drive mode information indicating at least one of the following: a data transfer mode for the external storage device set to the drive control unit, whether or not a recording medium is mounted on the external storage device, and information discriminating the recording medium mounted on the external storage device;
the information processing system further comprises a drive mode information recording unit for recording the drive mode information which is information at the time of suspending a power supply to the drive control unit, when the power control unit suspends supplying power to the drive control unit; and
when the request substitutional receiving unit receives the connection state request, the request substitutional replying unit reads the drive mode information from the drive mode information recording unit, and further returning the drive mode information as the connection state response.

15. The information processing system according to claim 14, wherein, when the request substitutional receiving unit receives a connection state request inquiring about whether or not the drive mode information of the external storage device has changed, the request substitutional replying unit returns as the connection state response a content indicating that the drive mode information of the external storage device has not changed.

16. The information processing system according to claim 14, wherein, when a power supply to the communication control unit is resumed, the power control unit acquires the drive mode information from the drive mode information recording unit, and sets the drive mode information to the communication control unit.

17. A computer program product comprising:
a computer readable medium; and
program code stored on the computer readable medium for controlling an information processing system which includes a central processing unit for executing an operating system, and an external storage device having a drive control unit for performing reading/writing operations on a recording medium in response to a request from the operating system, said program code including code that enables:
the drive control unit to transmit to the operating system a connection state response indicating that the external storage device is connected to the information processing system in an accessible state for reading/writing operations on the external storage device, when the drive control unit receives from the operating system a connection state request inquiring about whether or not the external storage device is connected to the information processing system in the accessible state;
a power control unit for suspending a power supply to the drive control unit;
a request substitutional receiving unit for receiving the connection state request from the operating system to the drive control unit in place of the drive control unit, when the power supply to the drive control unit is suspended; and
a request substitutional replying unit for returning the connection state response indicating that the external storage device is connected to the information processing system in the accessible state, when the request substitutional receiving unit receives the connection state request.

18. The computer program product of claim 17, wherein the program code for controlling the information processing system includes program code that when executed on the central processing unit enables a communication device having a communication control unit to control a communication unit communicating with an external device in response to a request from the operating system, wherein, when the communication control unit receives from the operation system a connection state request inquiring about whether or not the communication device is connected to the information processing system in an available state where the communication device is available to communicate with the information processing system, the communication control unit transmits to the operating system a connection state response indicating that the communication device is connected to the information processing system in the available state, said program code further comprising code that when executed enables:
the power control unit for suspending the power supply to the communication control unit;
the request substitutional receiving unit for receiving the connection state request to the communication control unit from the operating system in place of the communication control unit, when the power supply to the communication control unit is suspended; and
the request substitutional replying unit for returning the connection state response indicating that the communication device is connected to the information processing system in the available state, when the request substitutional receiving unit receives the connection state request.
